(19) United States
(12) Patent Application Publication
(10) Pub. No.: US 2016/0003385 A1
(43) Pub. Date: Jan. 7, 2016

(54) GASKET WITH COMPRESSION AND ROTATION CONTROL

(71) Applicant: William J. KOVES, Elgin, IL (US)

(72) Inventor: William J. KOVES, Elgin, IL (US)

(21) Appl. No.: 14/324,220

(22) Filed: Jul. 6, 2014

(51) Int. Cl. F16L 23/20; F16J 15/08

(52) U.S. Cl. CPC F16L 23/20; F16J 15/0887

(57) ABSTRACT

A multifunctional gasket with compression and rotation control comprises annular sealing element(s) with specific stiffness, geometry, tightness and compressibility properties and uniquely shaped compression element(s) with variable thickness and specific mechanical properties. The gasket is designed to seal under static and dynamic fluid pressure loading for a wide range of sizes and with severe thermal differential temperatures and static and dynamic external loads. This gasket is able to significantly increase the pressure rating for leakage, ability to resist external forces and moments, resistance to thermal differentials and operating reliability of flanges in accordance with published standards, as well as enable the more efficient design of special flanges for demanding operating conditions. The gasket design also allows for easier, faster and more uniform assembly of the joint.

### BACKGROUND OF THE INVENTION

1. Field of the Invention

The invention described herein is in the field of fluid containment at clamped conduit or chamber connections. In a general form the invention relates to joining conduits or chambers, each defining a connection body about an open end thereof, by a sealing structure clamped between opposing connection bodies defined at the end of the conduits or chambers. These connections are provided to prevent fluid leakage into or out of the chambers or conduit under temperature conditions, internal pressure loads, and/or external forces. In more specific form this invention provides a sealing structure, typically, in the form of a gasket, which is adapted when clamped between connection bodies, typically in the form of flanges, to seal the gap between the connection bodies around a chamber or conduit jointly defined by the connection bodies as the space there between. The sealing structure of this invention may be used, for example, for sealing the gap between flanges at the ends of pipes, pipe to nozzle connection on vessels, or the body flanges on heat exchangers.

2. Description of the Prior Art

U.S. Pat. No. 5,823,542 ('542 patent), which issued to Owen, discloses a spiral wound gasket. The '542 patent describes a spiral wound gasket able to compress and seal under very low loads and provide sealing capabilities. The gasket generally includes a spiral wound metal portion and an outer guide ring to limit the compression of the gasket. The addition of flexible graphite to the winding surface and the outer ring surface provides a more durable gasket with low sealing load requirements and elimination of buckling under sealing loads.

U.S. Pat. No. 5,794,946 ('946 patent), which issued to Owen, discloses a spiral wound gasket. The '946 patent describes a spiral wound gasket able to compress and seal under various loads and provide sealing capabilities. The gasket generally includes a spiral wound portion and an outer guide ring to limit the compression of the gasket. The spiral winding is formed of interdisposed windings of a metal and an elastomer sealant. The metal winding has a non-planar cross-section to inhibit buckling under compression. The gasket is dimensioned such that the elastomer sealant winding has a width greater than the width of the metal winding which has a width greater than the thickness of the guide ring. In this manner, the sealant is compressed before compression of the metal winding which can be compressed until the outer guide ring is encountered.

U.S. Pat. No. 5,664,791 ('791 patent), which issued to Owen, discloses a spiral wound gasket. The '791 patent describes a spiral wound gasket with outer ring also which includes means for preventing buckling of the spiral winding during compression. The outer compression ring provides a compression limit to prevent over-compression of the gasket. Note that prior art with spiral wound gaskets typically contain an outer guide ring. The outside diameter of the outer guide ring typically extends to the inside of the bolt holes and is used for centering the gasket on the flange. The outer guide ring also limits compression on the gasket when the raised face contacts the outer guide ring. The flange faces do not contact the outer ring, only the raised face, and the flange is free to rotate due to assembly and applied loads.

U.S. Pat. No. 5,421,594 ('594 patent), which issued to Becerra, discloses a corrugated gasket. The '594 patent describes gaskets having continuous multiple seals created by utilizing a core of functionally corrugated material encapsulated by a graphite material such that an interactive relationship exists between the graphite, the functionally corrugated core, and the surfaces to be sealed.

U.S. Pat. No. 6,318,732 ('732 patent), which issued to Hoyes, et al., discloses a resilient gasket. The '732 patent describes a gasket where the resilience is achieved by utilizing springy metal which resists being bent out of its initial shape. The '732 patent teaches the advantages of a gasketed joint with resilience in maintaining a leak tight joint.

U.S. Pat. No. 5,785,322 ('322 patent), which issued to Suggs and Meyer discloses a gasket made of a plate having a central opening with an annular region concentric to the gasket opening, the annular region having a plurality of concentric deformable ridges and opposite facing grooves in a first and second surface of the plate. A sealing material overlies the ridges and grooves.

The Handbook of Bolted Joints, Editors J. H. Bickford and S. Nasser, Chapter 24, Marcel Dekker, 1998, discusses the increased assembly efficiency and reduced bolt load variation with a stiff metal surface vs. a compliant gasket surface. U.S. Pat. No. 5,278,775 ('775 patent), which issued to Bible, Column 8, line 41 states that “It may therefore be concluded that an infinitely stiff flange without a gasket would have no interaction whereas a gasketed joint will behave differently with increased flange stiffness.”

U.S. Pat. No. 4,620,995 ('995 patent), which issued to Otomo, et al., discloses a sheet type gasket and teaches the relaxation properties of sheet type gaskets. Gasket sheets made of a joint sheet have an advantage of better stress relaxation properties; however, they have the disadvantage of poor conformability because of their hard surface material. Moreover, due to insufficient impermeability of the surface material, the mechanical properties of the gasket sheet, such as tensile strength, tear strength and bending strength, are affected adversely. In addition, it has been found that the binder in the surface material disintegrates from chemical attack causing damage to the surface material due to corrosion and/or unwanted adhesion. While the gasket sheets made of a beater sheet have the advantage of better conformability, they show rather poor stress relaxation properties. Surface treatment of the gasket sheet is necessary to improve the stress relaxation properties. Any relaxation of a sheet gasket in a flanged joint will translate into a reduced clamping load and reduced sealing gasket load.

### SUMMARY OF THE INVENTION

The problem addressed is improving the reliability of sealing structures used to join conduits or chamber having a sealing body located about opposing ends thereof and improving the ease of making connections that join conduits or chamber about such sealing structure. One specific type of sealing structure is in the form of a gasket for use in standard flanges that will solve the leakage problems with Standard ASME B16 Flanges and improve their pressure ratings with ease of reliable, reproducible assembly. There is the need to solve leakage problems in the field and to increase the pressure ratings of existing flanges for process unit revamps, without replacing the flanges. Pressure rotation, thermal rotation, axial thermal differentials, external loads and moments and the non-linear stress strain characteristics of conventional gasket materials are all issues that lead to leakage. The present invention generally relates to a gasket with compression and rotation control that addresses all of these issues, including increasing the pressure capacity of standard flanges without using special designed backup rings that add to the weight, allowing greater external loads, and greater ability to accommodate thermal differentials. The gasket design may be inserted into a standard flange pair in the field, with or without re-machining of the flange faces. It also enables easier, faster and more accurate assembly. These gaskets usually retain a sealing element that provides the primary resistance to fluid leakage about the gasket. It is often desirable to have the sealing element protected from the inside and/or outside environments.

The invention provides a type of sealing structure adapted to seal the gap between two connection bodies around a chamber or conduit when clamped there between. Such a sealing structure gasket may be used, for example, for sealing the gap between flanges at the ends of pipes or the pipe to nozzle connection on vessels or the body flanges on heat exchangers.

A gasket sealed joint is comprised of the two connection bodies that are joined together around a gasket and fasteners that can carry a tensile load for clamping the two connection bodies and compressing the gasket. The two bodies are conventionally called “Flanges” and the fasteners for clamping the flanges and gasket together are conventionally bolts or bolted clamp arrangements. Although bolts are most common, the connection bodies may be clamped together by any clamping structure that act together with the flange, such as bolts, or independently thereof such as a series of clamps located about the periphery of the flanges and positioned to urge the connection bodies together. Such clamping structures are familiar with those skilled in the art.

The further description of the sealing structure of this invention in the context of a gasket located between two flanges is not intended to limit the application of this invention thereto and the invention and the coverage applies broadly to any type of sealing structure as defined by the claims set forth herein.

The preferred embodiment of the gasket comprises a shape that typically covers the majority of the flange face, contains an inner compression zone, a annular sealing zone, and an outer compression zone and is typically tapered in thickness such that the inside surface is thicker than the outside surface. Typically the outer compression zone will contain holes to allow the bolts to pass through. However, there are special variations to the preferred design that still retain some of the advantages of the preferred design, such as no inner compression zone or a gasket comprised of a sealing element only.

The assembly of a joint comprised of two flange bodies and a gasket of this invention is faster, easier and more accurately loaded than conventional gasket sealed joints because of the controlled displacement and stiffness of the assembled joint. The flange bodies will contact either the sealing element or inner compression zone first depending on the taper angle and sealing element thickness. As the assembly load is applied it compresses the sealing element and the inner compression zone and causes the flange bodies rotate. Assembly is complete when the compressive load completely compresses the sealing element and when the flange bodies rotate a sufficient amount to have the respective flange faces contact the outermost compression zone that extends completely around the gasket. The stiffness of the compression zones is a function of their material(s) of construction, radial annular area, and thickness. The significant radial widths of the compression zones contribute to the high axial compressive stiffness of the assembled joint.

The flange types most suitable for use with the gasket have a flat sealing surface arrangement. In addition, for these flange types the rotational stiffness characteristics are such that the assembly clamping force as it continues to increase applies its force: first to the annular sealing element of the gasket to bring the adjacent portion of the flange face into contact therewith; secondly to the inner compression zone; and finally to one or more additional compression zones (herein referred to as outer compression and intermediate compression zones) that extend around the gasket to the outside of the inner compression zone. In most typical arrangements, by the time the force becomes applied to the any compression zone located outside of the inner compression zone it also causes full compression of any compression element located inboard of compression to which the force is applied

However, depending on the specific application, the flange face and the associated gasket may have an arrangement such that the flange face will contact the inner or outer compression elements first depending on the gasket taper angles. A very flexible flange may require a gasket with a greater taper angle. In the case of low pressure applications with high external bending moments a negative taper angle may provide a greater moment capacity with a negative taper angle, where the gasket is thicker at the outside diameter than the inside diameter. The gasket may also be adapted for flange faces with a raised face by incorporating a step change in the gasket thickness to match the raised face. The clamping of the joint together must be sufficient to achieve the full force required to compress the gasket to the required thickness and achieve the required forces on the compression zones. The joint is properly assembled when the flange rotates sufficiently such that the flange faces contact the outer compression zone of the gasket, limiting further rotation, after adequate preload has been applied to the inner compression zone and sealing element to resist the axial thrust forces due to pressure plus external loads and the required force to seat the sealing element. In addition the gasket requires sufficient residual force to maintain contact considering relaxation in the joint and all applied loadings, mechanical and thermal. If the flange faces are not parallel to each other, the taper angles on the gasket may be adjusted to accommodate the proper angle between the gasket faces and the flange faces. The gasket can accommodate a different taper angle on each side of the gasket to accommodate different flange designs on each side of the gasket.

The gasket sealed joint is dependent on the gasket design, the flange design and the clamping design. For “Standard Flanges” (eg. flanges to a specific standard such as ASME B16.5) the gasket is designed to work with the specified flange and bolting. For “Special Flanges” the flange, gasket and bolting are designed to optimally work together. The gasket is able to achieve greater pressure ratings than conventional raised face flanges because of several design advantages. The axial component of pressure is primarily reacted at the inner compression zone near the inside diameter close to the line of action of the applied load thereby minimizing the bending moment on the flange due to pressure and external mechanical loads. The primary bending stresses due to pressure and external mechanical loads is also reduced due to the opposing moment from the outer compression element reaction force. The flange rotation due to axial and radial pressure thrusts is also resisted by the gasket compression elements. Higher assembly loads can also be achieved because the flange stresses are displacement limited. The contact of the flange face with the gasket compression surfaces resists rotation of the flange, maintaining compression of the annular sealing element and maintaining bolt displacement. The limited rotation by the gasket also resists rotation and unloading of the annular sealing element due to thermal differentials between the flange neck and ring. The flange rotational stiffness can also accommodate some axial thermal differential between the bolts and flanges without unloading the gasket. The solid intimate contact between the gasket sealing and compression elements and the flange faces makes for more uniform temperatures between the flanges, gasket elements and bolts due to both steady state operating temperatures and transient thermal differential temperatures. The gasket also has a much greater blowout capacity than a conventional gasket design due to the wide radial width, that may extend from the inside diameter to the outside diameter, and a positive taper angle also increases the blowout resistance. The gasket also has a much greater external force and moment capacity than a conventional raised face flange/gasket design due to the wide radial width, that may extend from the inside diameter to the outside diameter creating a high effective moment of inertia. After the flange joint is assembled the typical gasket sealing element is completely contained between the inner and outer compression elements and displacement controlled. Flange rotation is limited by contact with the gasket compression elements. The gasket sealing element will see only very minor changes in compressive stress due to variations in operating pressures, external forces, and temperature differentials. The gasket stress in a conventional raised face design will vary with changes in pressure, external loads, and thermal differentials. This can lead to gasket ratcheting and leakage that is prevented by the gasket design. These features make the flange and gasket sealed joint with a gasket able to withstand greater pressures, external forces and moments, and temperature differentials than a conventional raised face flange joint.

The advantages of a rigid vs. flexible gasket in achieving more uniform gasket stress is well known to those experienced in the art of flange joint assembly. Multiple passes of bolt torque are not required. Residual compression of the outer compression zone can be achieved by a specified turn of the nut after contact. All flange and bolt stresses are displacement limited and high flange secondary stresses can be tolerated. Conventional gasket sealed joint assembly is subject to uncertainties due to elastic interaction, requiring multiple passes of bolt torque. Friction also introduces scatter in bolt torque versus load correlations resulting in less accurate assembly stresses. Physical limits on excessive flange stresses are not provided in conventional joints. The gasket design has the advantages of uniform displacement controlled sealing element stresses due to the more rigid compression elements and the advantages of the better sealing characteristics of the softer, more compliant, sealing element.

The gasket prior art describes the advantages of an outer guide ring to limit the compression of spiral wound gaskets, the advantages of joint resiliency and the use of multiple sealing surfaces. The prior art does not address the strength and stiffness of the mating flanges and clamping bolts, rigidity of the assembled joint or limiting and controlling rotation of the flanges. The theory of operation of the gasket is that the inner compression zone and sealing element are compressed with a load sufficient to “seat” and compress the sealing element and react the axial pressure thrust and the axial component of external loads and moments prior to the flange rotating the amount necessary to make contact with the outer compression zone. The residual load on the outer compression zone is sufficient to accommodate any relaxation in the joint and maintain contact. When high external bending moments are required to be accommodated greater residual compression may be required on the outer compression element and negative taper angles may be required. This would be a special, not typical, application of the gasket and assembly would be typically based on bolt torque requirements. The proper assembly load is easily achieved with a gasket with positive taper angle because the joint is assembled when the flange contacting faces make contact with the surface of the gasket at the outside diameter creating “metal to metal” contact. Any additional preload required can be easily applied by the “turn of the nut” method or other methods known to those experienced in the assembly of bolted flange joints. This is easily achieved by an assembler with little training or experience, whereas conventional gasket sealed bolted joints require trained and qualified specialists and require more bolt tightening passes and time to assemble. During the application of external static and dynamic mechanical and thermal loads the gasket compression zones remain in compression, the flange rotation is fixed and the gasket compression remains unchanged. The axial loads will be reacted by unloading the stiffer compression elements. The unloading of the inner compression element will react with the axial applied loads along a line of action close to the effective line of action of the applied loads thereby greatly reducing the bending moment on the flange as compared with a raised face flange with a conventional gasket.

Maintaining a reliable seal in a gasket sealed joint can be challenging when the operating and loading conditions are severe. Several mechanisms attempt to unload the gasket in a conventional flange joint with a gasket: axial pressure thrust, pressure rotation of the flange, dynamic hydraulic and seismic loads, axial thermal differentials, thermal rotation of the flange, gasket relaxation, and gasket ratcheting. The gasket sealed joint design addresses each of these mechanisms preventing the mechanism from degrading the seal and maintaining pressure rating while being a joint that provides for easy and reliable practical assembly in the field.

### BRIEF DESCRIPTION OF THE DRAWINGS

Other features of my invention will become more evident from a consideration of the following brief description of patent drawings:

FIG. 1 is a depiction of a gasket sealed joint comprised of two flat faced flanges, a gasket with a single annular sealing zone, two annular sealing elements, inner and outer compression zones and clamping of the flanges by bolt fasteners. The two annular sealing elements are located in the single annular sealing zone in two respective annular recesses located on opposing sides of the annular compression element. The annular recesses have a radial width and depth sufficient to contain the annular sealing elements. The first annular sealing element creates a seal with the first body and the second annular sealing element creates a seal with the second body when clamped together.

FIG. 2 is a depiction of a gasket sealed joint comprised of two raised faced flanges, a gasket with a single annular sealing element, inner and outer compression zones and clamping of the flanges by bolt fasteners.

FIG. 3 is a depiction of a gasket comprised of an inner and outer annular compression zone and a single integral annular sealing zone. The annular sealing element is integral with the compression element.

FIG. 4 is a depiction of a gasket comprised of inner, intermediate and outer annular compression zones and two (multiple) annular sealing zones. There is a single compression element, comprised of multiple compression zones and multiple annular sealing elements.

FIG. 5 shows a single unitary compression zone with an integral gasket located at the inner surface of the gasket.

FIG. 6 is a plan and cross sectional view of a possible irregular gasket shape.

### DETAILED DESCRIPTION OF THE INVENTION

Throughout the description of this invention the following terms and associated definitions apply:

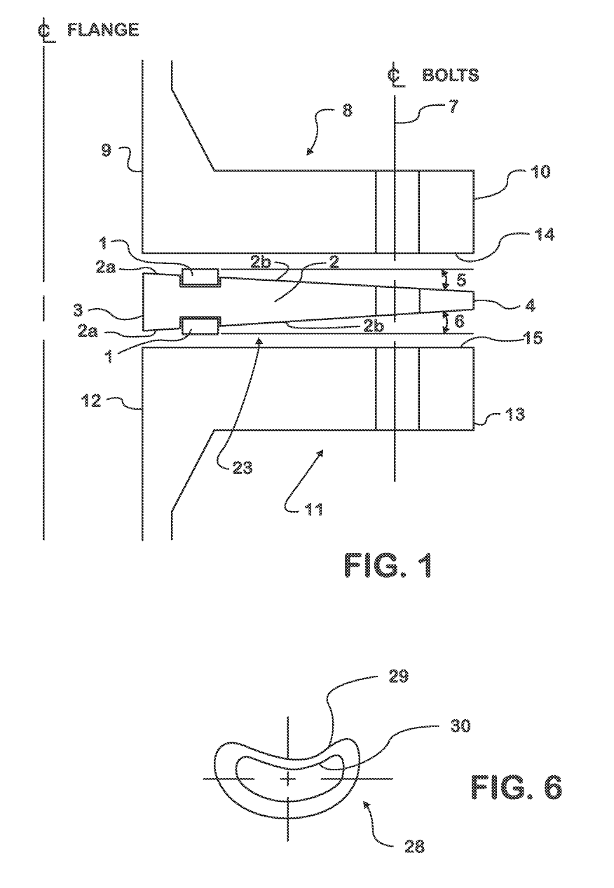

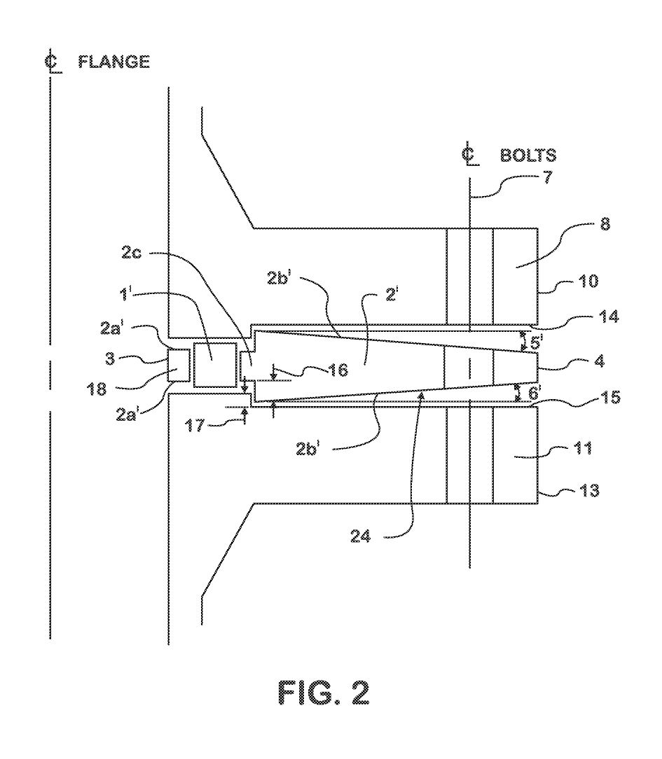

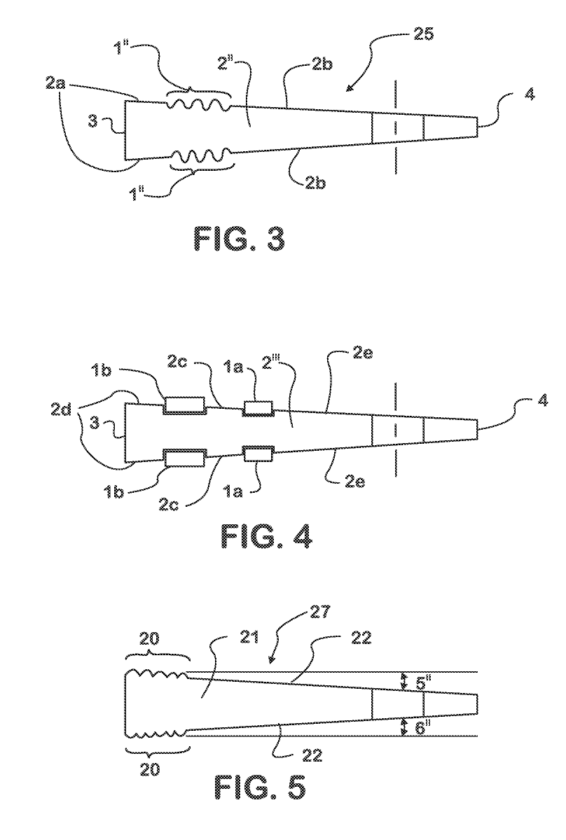

“annular sealing element”: For gaskets with an axisymmetric shape this is an annular shaped element of approximately constant radial width. For gaskets with a non-axisymmetric shape the “annular sealing element” is a shape with an inner and outer surface that approximately follows the same shape as the inner boundary of the gasket with an approximately constant width as measured normal to the inner surface of the “annular sealing element” to its outer surface (eg. the radial distance in the case of axisymmetric geometries). In all cases the “annular sealing element” is comprised of a type of construction and/or material suitable for creating a fluid tight seal, either self sealing or requiring compression and such element(s) may or may not be integral with the compression element. When the sealing element is not integral with a compression element it is comprised of a non-integral sealing element. An example of a non-integral sealing element is spiral windings with filler and a configuration such as shown in FIG. 2. An example of an integral sealing element is a metal zone comprised of concentric serrations with or without a surface coating, such as shown in FIG. 3. The thickness of either may vary in the radial direction or be constant.
“annular sealing zone”: This is an annular shaped zone of approximately constant radial width and encompassing the “annular sealing element(s)” within the zone and the full thickness of the gasket. For gaskets with a non-axisymmetric shape the “annular sealing zone” is a shape as described for the annular sealing element. An annular sealing zone may encompass more than one annular sealing element. The gasket illustrated by FIG. 4 contains two annular sealing zones and four annular sealing elements.
“annular compression element”: For gaskets with an axisymmetric shape this is an annular shaped zone of approximately constant radial width. For gaskets with a non-axisymmetric shape the “annular compression element” is a shape with an inner and outer surface that approximately follows the same shape as the inner boundary of the gasket with an approximately constant width as measured normal to the inner surface of the “annular compression element” to its outer surface (eg. the radial distance in the case of axisymmetric geometries). In all cases an “annular compression zone” is comprised of a type of construction and/or material that has a compressive stiffness greater than the “annular sealing element(s)” of the gasket. The thickness may vary in the radial direction or be constant. An annular compression element may also provide sealing capabilities, although that is not its primary function. A gasket is comprised of one or more “annular compression elements” and one or more “annular sealing elements.” An “annular compression element” may contain multiple “annular compression zones, each loaded to different stress levels.” The gasket of FIG. 1 contains one annular compression element and two annular compression zones, whereas the gasket of FIG. 2 is comprised of two annular compression elements and two annular compression zones.
“annular compression zone” is a zone of the annular compression element with an inner and outer perimeter that approximately follows the same shape as the inner boundary of the gasket with an approximately constant width as measured normal to the inner surface of the “annular compression zone” to its outer perimeter (eg. the radial distance in the case of axisymmetric geometries). An annular compression element is comprised of one or more annular compression zones. The gasket illustrated in FIG. 1 is comprised of an inner compression zone, that extends from the inside diameter of the gasket to the inside diameter of the annular sealing zone, and an outer compression zone that extends from the outside diameter of the annular sealing zone to the outside diameter of the gasket. In the case of multiple sealing elements, there will be intermediate annular compression zones between sealing elements, such as in FIG. 4.
“flanges”: Flanges are bodies with surfaces for contacting the gasket, of a design that allows the flanges to be clamped together compressing the gasket between the flange faces to create a fluid seal and of a design with appropriate structural strength and rigidity to withstand the clamping forces and all imposed loading. The types of flanges include, but is not limited to, integral, loose, and reverse, as described and shown in ASME Boiler and Pressure Vessel Code, Section VIII, Division 1, Appendix 2 and clamp type connectors, including those as described in Appendix 24. However the design shape may be any shape that can clamp and seal the gasket including non-circular elliptical and rectangular flanges. The ideal embodiment is a flange design with appropriate geometry and rigidity compatible with the gasket shape as described herein.
“gasket”: This invention describes a gasket that comprises sealing element(s) and compression element(s). When the term gasket is used herein it includes all elements. Conventional terminology uses the term gasket when referring to sealing elements or sealing elements with compression elements. The term “conventional gasket” refers to these conventional designs.
“inside or outside diameter”: The gasket elements typically have an axisymmetric geometry with an inner and outer radius. However, there are cases where the gasket elements are not axisymmetric, such as for elliptically shaped flanges. In those cases when the term inside or outside diameter is used it is referring to the inside or outside perimeter, since it is not a true diameter.
“Kammprofile gasket”: A gasket comprised of a concentrically serrated solid metal core with a soft, conformable sealing material bonded to each face.
“pressure energized sealing element”: Sealing elements where the element deforms under internal pressure creating contact stresses between the element and the mating bodies in excess of the internal pressure thereby maintaining a seal.
“taper angle”: The “first body taper angle” is defined as the angle between a line drawn in a radial plane in the contacting surface of the first body and a line drawn in a radial plane from a point on the surface of the gasket closest to the first body, at the innermost diameter of the innermost compression element, to a point on the surface of the gasket closest to the first body, at the outermost diameter of the outermost compression element. The “second body taper angle” is defined as the angle between a line drawn in a radial plane in the contacting surface of the second body and a line drawn in a radial plane from the surface of the gasket closest to the second body, at the inner diameter of the innermost compression element, to a point on the surface of the gasket closest to the second body, at the outer diameter of the outermost compression element. The first and second body taper angles typically range from zero degrees to less than approximately 10 degrees and preferably from 0.01 to 3 degrees, however it is possible to have a negative taper angle if the mating flanges are tapered an excessive amount.

FIG. 1 illustrates one embodiment of the gasket of this invention in a gasket sealed joint with an axisymmetric geometry comprising two flanges, 8, and 11; the gasket 23 comprised of two annular sealing elements 1, an annular compression element 2, annular compression zones 2a and 2b with variable thickness; clamping the joint together consisting of bolt holes and bolt fasteners centered along centerline 7. Although bolts are the fasteners used to clamp the joint together as illustrated herein, other clamping structures may also be employed such as bolted clamp connectors. The compression zones are tapered in thickness with upper taper angle 5 and lower taper angle 6 each forming a frustro-conical surface. Flange 8 has inside diameter 9 and outside diameter 10. Flange 11 has inside diameter 12 and outside diameter 13. The typical and preferred embodiment of the gasket for the gasket sealed joint would be comprised of flanges 8 and 11 with approximately the same inside and outside diameters and similar design, however there are no restrictions on flange inside or outside diameters for the application of the gasket of this invention in a gasket sealed joint other than the gasket inside diameter 3 should preferably be greater than or equal to the greater of the flange inside diameters 9 and 12 and the gasket outside diameter 4 should preferably be less than or equal to the smaller of flange outside diameters 10 and 13. The outside diameter 4 of the gasket should preferably extend beyond the bolt circle as defined by the bolt centerline 7. However some benefits of the gasket design are retained if the outside diameter is equal to the inside diameter of the bolt circle.

FIG. 2 illustrates another gasket 24 designed in accordance with this invention comprised of an annular sealing element 1′ and two annular compression elements comprised of inner compression element 18 and outer compression element 2′ that define annular compression zones 2a′ and 2b′ respectively. (The same reference numbers designate like elements in the Figures) The gasket 24 varies in thickness from the inside diameter 3 to outside diameter 4. The compression zones are tapered in thickness with upper taper angle 5′ and lower taper angle 6′ each forming a frustro-conical surface. The annular sealing element is not integral with the compression elements and the outer annular compression element 2′ is “stepped” in geometry by a distance 16 to provide a thinner portion 2c that matches the step distance 17 of flange raised face. The “stepped” geometry may be applied to any gasket design of this invention with any combination of sealing and compression elements.

FIG. 3 illustrates a gasket 25 designed in accordance with this invention and comprised of a single annular compression element 2″ having an inner and outer annular compression zones 2a and 2b respectively, a single annular sealing element 1″ comprising a surface of formed serrations. The gasket 25 again varies in thickness from the inside diameter 3 to outside diameter 4. The annular sealing element 1″ is an integral part of the compression element 2″.

FIG. 4 illustrates a gasket 26 designed in accordance with this invention having: four annular sealing elements, 1a and 1b, each retained at different radial locations along gasket 26, and located on both of its transverse sides; and a single compression element 2′″ comprised of inner compression zone 2d, outer compression zone 2e and intermediate compression zone 2c. When in use, one or both sides of the intermediate compressions zone 2c may not have compressive contact with the adjacent flange face. The gasket illustrated in FIG. 4 may find preferred application in the handling hazardous fluids.

For the application of handling hazardous fluids or for other purposes, a sensing element may in communication with one or both of the compression zones 2c or a fluid volume confined by volume bordered by zone 2c the outside and inside of compression elements 1b and 1a, respectively, and the portion of the adjacent flange face located above zone 2c. The sealing element may monitor relative or absolute pressure in the confined volume as an indication of leakage or for other purposes.

FIG. 5 shows a gasket 27 having a single unitary compression zone 21 comprising an integral sealing element 20 located at the inner surface of gasket 27. The compression element 21 tapers in thickness with upper taper angle 5″ and lower taper angle 6″ each forming a frustro-conical surface 22 on and adjacent to the surfaces of compression zone 21. Taper angles 5″ and 6″ may vary from each other desired to accommodate the mating flanges.

FIG. 6 shows a plan view and a cross sectional view of an irregularly shaped gasket 28 having an outer periphery 29 and an inner circumference 30. FIG. 6 demonstrates the broad range of possibilities for the shape of the gaskets to which this invention may apply; that a gasket of this invention may have irregular convex and concave regions around the course of its inner and outer surfaces; and the shape of inner and outer surfaces of the gasket need not match. Furthermore, although not shown, the gasket may have an inwardly or outwardly reducing taper.

The typical gasket design would have a single annular sealing element with one or more compression elements, however multiple annular sealing elements are also acceptable, such as described above. The annular sealing elements may be integral with the compression elements of the gasket as shown in FIG. 3 or non-integral elements such as illustrated in FIG. 2. The overall gasket varies in thickness typically being thicker at the inside diameter and thinner at the outside diameter. FIG. 1 illustrates the gasket with a uniform taper from the inside diameter 3 to the outside diameter 4 with a taper defined by taper angles 5 and 6.

In reference to FIG. 1, the preferred embodiment of the gasket is with a uniform taper and if flanges 8 and 11 are identical, taper angles 5 and 6 will be equal. However, a gasket design with a non-uniform change in thickness from the inside diameter to the outside diameter may also achieve acceptable sealing capability and such designs are discussed further below. Taper angles 5 and 6 depend on the clamping load to fully compress the annular sealing element, all applied loads and the rotational stiffness of flanges 8 and 11 respectively. The preferred embodiment of the gasket sealed joint is as follows: flange faces 14 and 15 will have rotated angles 5 and 6 respectively when the total uniform load provided by the bolt fasteners during assembly of the joint is equal to or greater than the load required to resist the axial pressure thrust and external loads and compress the annular sealing element such that the flange faces 14 and 15 are in contact with the compression elements adjacent to the annular sealing element. It is preferred, but not required, that an annular compression element be inboard of the innermost sealing element to react the pressure thrust load. When flange 8 rotates under bolt load such that face 14 is in contact with the gasket from the inside diameter 3 to the outside diameter 4 the gasket sealed joint has been assembled to the minimum required bolt stress. Additional bolt stress is beneficial in increasing bolt strain to accommodate relaxation of the joint and providing compressive stress to cause frictional resistance to radial movement of the gasket relative to the flange faces for thermal events.

A gasket with non-uniform taper may embody several different designs. A practical embodiment of the gasket is with annular sealing elements with uniform thickness as in a conventional gasket design and uniformly tapered compression elements. Another embodiment of the gasket with non-uniform taper is with compression elements comprised of segments with uniform thickness, stepped to create a cross section of varying thickness with increasing radial dimension. Any combination of tapered or stepped elements may be used to comprise a gasket with varying thickness. The angles 5 and 6 may be approximated by the angle measured from a line drawn from the surface point at the inside surface 3 and the outside surface 4 with a horizontal line.

Flange contacting faces 14 and 15 may also be tapered in a frustro-conical shape and the taper angles on the gasket adjusted accordingly and could be as small as zero. The gasket taper angles 5 and 6 are measured relative to the flange contacting faces 14 and 15 respectively. There may or not be a compression element inboard of the annular sealing element, even the preferred embodiment is with a compression element inboard of the annular sealing elements. FIG. 5 illustrates a gasket design with an annular sealing element at the inner diameter and a tapered annular compression element outboard of the annular sealing element. Taper angles 5 and 6 are shown for the case when an annular sealing element is located at the inner diameter. This gasket design may be necessary when the application requires the seal to be at the innermost diameter of the gasket.

The annular sealing element design preferred embodiment is such that the gasket stress after relaxation in operation is greater than the stress required to maintain a fluid seal with greater than the required tightness. This annular sealing element minimum stress is generally not less than the fluid pressure contained and typically much greater. The required gasket stress levels for specific tightness levels may be estimated by those experienced in the art. The clamping force and flange bodies must be capable of compressing the gasket to the fully compressed thickness. The fully compressed thickness for the annular sealing element is when the flange faces are compressed to contact with the compression elements adjacent to the annular sealing element. The exception is if the gasket is comprised of a single tapered sealing element, in which case the required gasket stress is dependent on the gasket properties and the mechanical and thermal loadings on the joint. The optimum stress on the annular sealing element during assembly of the joint and the minimum required stress on the annular sealing element after the joint has experienced operation conditions for a period of time such that the annular sealing element has fully relaxed, are properties of specific annular sealing elements. The design of annular sealing elements is a specialized art and those experienced in the art can recommend values of annular sealing element stress for assembly, annular sealing element stress-strain properties, short and long time creep and relaxation properties, and leak tightness properties at minimum annular sealing element stress levels.

1. A gasket for joining two conduits by contacting and sealing two opposing connection bodies located at the ends of the conduits to form a sealed and load bearing connection of the two conduits along a common axial centerline by the clamping of connection bodies together about a gasket having a general planar closed or elongate hollow tubular shape with an inner perimeter and an outer perimeter, the gasket comprising:
a) an elongate hollow tubular gasket body containing a central opening leading to a central hollow, the opening corresponding to the shape of the connection bodies in an assembled condition, and the thickness of at least a portion of the gasket body varies with increasing distance from the centerline;
b) at least one compression element extending around the entire perimeter of the gasket body;
c) at least one compression zone defined by and extending around the entire perimeter of the at least one compression element, and being in direct contact with adjacent faces of the connection bodies when a connection is assembled, and having a predetermined stiffness, wherein any additional compression zones are, with respect to the at least one compression zone, spaced apart radially;
d) at least one resilient sealing element, either non-integral or integral to the at least one compression element and extending continuously around the perimeter of the gasket body and the at least one sealing element having a stiffness less than 0.67 times the stiffness of the at least one compression zone; and
e) at least one pair of sealing surfaces with the at least one sealing element defining at least one sealing surface that continuously extends around at least a portion of the at least one sealing element and at least one pair of sealing surfaces being in radial alignment over a transverse width of the gasket body and wherein the at least one pair of sealing surfaces contacts adjacent faces of the connection bodies when the connection is assembled.

2. The gasket of claim 1 wherein the at least one sealing element provides sealing surfaces at opposite positions along the perimeter to provide a pair of sealing surfaces located radially between two compression elements and the gasket retains the sealing element to provide a sealing surface at opposite positions along the perimeter of the gasket.

3. The gasket of claim 1 wherein the gasket retains two sealing elements and opposing connection bodies each located at opposite positions along the perimeter of the gasket body between two compression zones and each sealing element provides a sealing surface for contact with one of the opposing connection bodies.

4. The gasket of claim 1 wherein the thickness of at least a portion of the gasket body decreases with increasing distance from the centerline.

5. The gasket of claim 4 wherein at least a portion the thickness of the gasket body decreases in stepwise fashion.

6. The gasket of claim 4 wherein at least a portion of the thickness of the gasket body decreases uniformly.

7. The gasket of claim 1 wherein the perimeter of the gasket has a circular, an ellipsoidal, or an obround shape.

8. The gasket of claim 1 wherein the opposing connection bodies are clamped using bolts.

9. The gasket of claim 8 wherein the gasket extends outwardly past the bolts and defines holes through which the bolts pass.

10. The gasket of claim 1 wherein the at least one compression element retains a first pair of sealing elements located at opposite positions along the perimeter of the gasket body and spaced apart from a second pair of sealing elements located at opposite positions along the perimeter of the gasket body that together divide the compression element into three compression zones.

11. The gasket of claim 1 wherein the at least one sealing element is integral with the at least one compression element and defines sealing surfaces located at opposite positions along of the compression element and the sealing element divides the compression element into two radially separated compression zones.

12. The gasket of claim 1 wherein the gasket body has grooves and lands extending around the perimeter thereof which match grooves and lands in a face of the connection bodies between which the gasket body is clamped.

13. The gasket of claim 1 wherein the at least one compression element has a continuous taper in the radial direction to form a frustro-conical shape having an angle of less than 10 degrees between a radial plane of the compression element and a surface of the compression element and preferably an angle of from 0.01 to 3.0 degrees.

14. The gasket of claim 1 wherein the clamping of the gasket and connection bodies together contains the gasket radially and axially.

15. The gasket of claim 1 wherein at least one face of the sealing surface and the compression zone causes the compression zone and the at least one sealing surface at opposite positions along the perimeter of the gasket body to come into contact with an adjacent face of the connection body by the clamping of the bodies together.

16. The gasket of claim 15 wherein a transverse profile of the gasket body provides a frusto-conical gap between the connection bodies and the gasket further brings the at least one compression element into contact with cooperating connection bodies upon clamping of the corresponding connection bodies about the gasket.

17. A gasket for joining two conduits by contacting and sealing two opposing metallic flanges together to form a sealed and load bearing connection of the two conduits along a common axial centerline by the clamping of flanges together about a body of the gasket, the gasket comprising:
a) the gasket body having a shape that corresponds to the shape of the opposing flanges and wherein the thickness of at least a portion of the gasket continually decreases with increasing distance from the centerline;
b) at least one metallic compression element defined by and extending around a perimeter of the gasket body;
c) at least two compression zones defined by and extending around the perimeter of the at least one compression element, adapted for metal to metal contact with an adjacent face of a conduit flange when a connection is assembled, and having a predetermined stiffness, wherein any additional compression zones are, with respect to any other compression zone, spaced apart radially and have a thickness adapted to define a triangular gap between the opposing metallic flanges and the gasket body prior to clamping of the opposing metallic flanges together and to close said gap after fully clamping the connection together;
d) at least one sealing element non-integral or integral to the at least one compression element and extending around the gasket perimeter between two compression zones and the at least one sealing element having a stiffness less than 0.67 times the stiffness of the compression zone with a lowest stiffness; and,
e) at least one pair of sealing surfaces with each sealing surface defined by and extending around at least a portion of the perimeter of the at least one sealing element and each pair of sealing surfaces being in radial alignment across opposite transverse faces of the gasket and is located between two compression zone with each sealing surface adapted to directly contact and compress against an adjacent face of a conduit flange when the connection is assembled.

18. The gasket of claim 17 having an outermost compression element with a diameter equal to a diameter of a smallest flange in the connection.

19. The gasket of claim 17 being comprised of a single sealing element and an inner compression element that extends from an inside diameter of the gasket to an inside diameter of the sealing element and an outer compression element that extends from an outside diameter of the sealing element to an outside diameter of the gasket.

20. The gasket of claim 17 wherein the sealing element is selected from the group comprising Spiral Wound and Kammprofile sealing elements.

21. The gasket of claim 17 wherein the compression element has at least one raised face or recess that is adapted to be spaced apart from the flange when the flange is first brought into contact with the gasket and into full contact with the flange when the flange is fully clamped.

22. The gasket of claim 17 wherein one sealing element provides sealing at opposite positions along a perimeter thereof to provide a pair of sealing surfaces located radially between two compression elements and the gasket retains the sealing element to provide a sealing surface at opposite positions along the perimeter of the gasket.

23. The gasket of claim 17 wherein the gasket retains two sealing elements located at opposite positions along the perimeter of the gasket body between two compression zones and each sealing element provides a sealing surface for contact with one of the opposing metallic flanges.

24. The gasket of claim 17 wherein the thickness of the compression elements decreases uniformly with increasing distance from the centerline.

25. The gasket of claim 17 wherein the at least one sealing element is integral with the at least one compression element and defines sealing surfaces located at opposite positions along the compression element and the sealing element divides the compression element into two radially separated compression zones.
